(19) United States
(12) Patent Application Publication
(10) Pub. No.: US 2019/0034561 A1
(43) Pub. Date: Jan. 31, 2019

(54) SYSTEM AND METHOD FOR INTEGRATING ORTHOGRAPHIC PARAMETERS WITH STRUCTURAL MODEL PARAMETERS WITHIN A COMPUTER AIDED DESIGN ENVIRONMENT

(71) Applicant: Design Data, Inc., Lincoln, NE (US)

(72) Inventors: Damon E. Scaggs, Lincoln, NE (US); William D. Axline, Lincoln, NE (US)

(73) Assignee: Design Data, Inc., Lincoln, NE (US)

(21) Appl. No.: 16/146,890

(22) Filed: Sep. 28, 2018

Related U.S. Application Data
(63) Continuation-in-part of application No. 13/861,467, filed on Apr. 12, 2013.
(60) Provisional application No. 61/624,209, filed on Apr. 13, 2012.

(51) Int. Cl. G06F 17/50; G06T 7/00; G06T 15/00; G06T 11/60; G06T 19/20

(52) U.S. Cl. CPC G06F 17/50; G06T 7/0006; G06T 15/00; G06T 2219/2012; G06T 19/20; G06T 2207/30136; G06T 11/60

(57) ABSTRACT

The present invention discloses a system and method for integrating orthographic parameters with structural model parameters within a computer aided design environment. According to a first preferred embodiment, a system and method are disclosed which analyze the relationship between selected orthographic parameters of a structural member and structural model parameters of the structural member. According to a further preferred embodiment, the present invention includes a module to extract and parse data to analyze orthographic parameters and corresponding structural model parameters associated with the structural member.

### CROSS-REFERENCE TO RELATED APPLICATIONS

The present application is a Continuation-In-Part of U.S. application Ser. No. 13/861,467 filed Apr. 12, 2013; which claims priority to U.S. Provisional Application Ser. No. 61/624,209 filed on Apr. 13, 2012 which is incorporated by reference in its entirety herein.

### FIELD OF INVENTION

The present invention is related in general to design software, and in particular, to a system and method for integrating orthographic parameters with structural model parameters within a computer aided design environment.

### BACKGROUND OF THE INVENTION

Three-dimensional (3D) design software is now commonplace and essential to creating finished products of all kinds. However, not all steps and stages of every design process requires 3D rendering and many reviewers of 3D designs do not have access to the processing power needed to render and edit three-dimensional drawings. Further, the extensive detail of 3D objects files are often cumbersome and unnecessary for designers working on specific details of larger projects. Additionally, many projects limit the number of designers who can make direct changes to larger project files. For this reason, detailed 2D documents and drawings are commonly produced for the manufacture and detailing of smaller components. For example, steel detailers may utilize 2D computer-aided drafting (CAD) software to design steel beams which are small parts of larger 3D building designs.

An important drawback to separately editing 2D images/files and 3D images/files is that edits to designs are often not easily controlled or transferred. In particular, different CAD designers may introduce changes into a given design detail which are not desirable or recognizable to other 3D designers and programs.

### SUMMARY OF THE INVENTION

To solve the issues of prior art, the present invention discloses a system and method for integrating orthographic parameters with structural model parameters within a computer aided design environment. According to a first preferred embodiment, a system and method are disclosed which analyze the relationship between selected orthographic parameters and structural model parameters of given structural elements. According to a further preferred embodiment, the present invention includes a module to extract and parse data to analyze orthographic parameters and corresponding structural model parameters associated with the structural member.

According to a further exemplary embodiment, aspects of the present invention include a computing device and an algorithm which may analyze whether an orthographic parameter associated with a structural member at least approximately equals a structural model parameter associated with the structural member.

According to a further preferred embodiment, the computing device may include a display device, a memory, and a processor communicatively coupled to the display device and the memory. The computing device includes a module stored in memory and executable by the processor. The module is configured to detect an input to analyze an orthographic parameter associated with a structural member represented in an orthographic environment, which is displayed by the display device, with a corresponding structural model parameter associated with the structural member. The processor is then configured to determine whether the orthographic parameter equals the corresponding structural model parameter. The processor is then configured to cause display of the orthographic parameter within the orthographic environment. The parameter may be displayed in a first hue when the orthographic parameter equals the corresponding structural model parameter.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and to improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness. Where methods are shown, it should be understood that the method steps are exemplary and that selected steps may be omitted or added without limitation. Further, the steps of the illustrated methods are provided in a given order for clarity only. Alternatively, the steps of the illustrated methods may be performed in any logical order without limitation.

FIG. 1 is a block diagram of a system in accordance with an example implementation of the present disclosure.

FIGS. 2A and 2B are graphical illustrations of structural members represented within an orthographic environment (3D environment) in accordance with example implementations of the present disclosure.

FIG. 3 is a flow diagram illustrating an example process in accordance with the present disclosure.

FIG. 4 is a flow diagram illustrating a further example process in accordance with the present disclosure.

FIG. 5 is a flow diagram illustrating a further example process in accordance with the present disclosure.

FIG. 6 is a flow diagram illustrating a further example process in accordance with the present disclosure.

### DETAILED DESCRIPTION OF EMBODIMENTS

Reference is now made in detail to the exemplary embodiments of the invention, examples of which are illustrated in the accompanying drawings. The description, embodiments and figures are not to be taken as limiting the scope of the claims. It should also be understood that throughout this disclosure, unless logically required to be otherwise, where a process or method is shown or described, the steps of the method may be performed in any order, repetitively, iteratively or simultaneously. As used throughout this application, the word “may” is used in a permissive sense (i.e., meaning “having the potential to’), rather than the mandatory sense (i.e. meaning “must”).

Additionally, any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

Further, various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

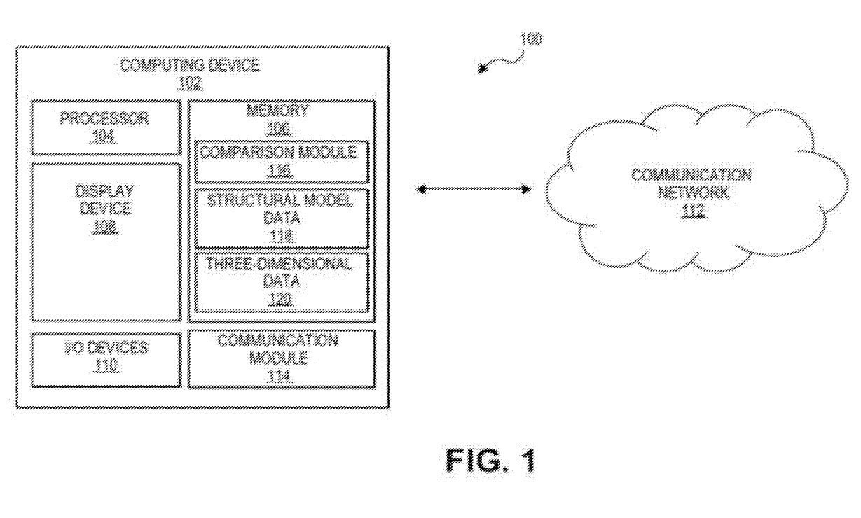

FIG. 1 illustrates a system 100 for determining whether parameters of an orthographic (three-dimensional or 3D) model (e.g., structural member is represented in an orthographic environment) at least approximately matches, or equals, the corresponding structural member model. As shown, the system 100 includes a computing device 102. In one or more implementations, the computing device 102 may be a server, a desktop computing device, a laptop computing device, or the like. As shown in FIG. 1, the computing device 102 includes a processor 104 and a memory 106.

The processor 104 provides processing functionality for the computing device 102 and may include any number of processors, micro-controllers, or other processing systems and resident or external memory for storing data and other information accessed or generated by the computing device 102. The processor 104 may execute one or more software programs (e.g., modules) that implement techniques described herein.

The memory 106 is an example of tangible computer-readable media that provides storage functionality to store various data associated with the operation of the computing device 102, such as the software program and code segments mentioned above, or other data to instruct the processor 104 and other elements of the computing device 102 to perform the steps described herein.

The computing device 102 is also communicatively coupled to a display device 108 to display information to a user of the computing device 102. In embodiments, the display device 108 may comprise an LCD (Liquid Crystal Diode) display, a TFT (Thin Film Transistor) LCD display, an LEP (Light Emitting Polymer) or PLED (Polymer Light Emitting Diode) display, and so forth, configured to display text and/or graphical information such as a graphical user interface. For example, the display 108 displays visual output to the user. The visual output may include graphics, text, icons, video, interactive fields configured to receive input from a user, and any combination thereof (collectively termed “graphics”).

As shown in FIG. 1, the computing device 102 is also communicatively coupled to one or more input/output (I/O) devices 110 (e.g., a keyboard, buttons, a wireless input device, a thumbwheel input device, a track stick input device, a touchscreen, and so on). The I/O devices 110 may also include one or more audio I/O devices, such as a microphone, speakers, and so on.

The computing device 102 is configured to communicate with one or more other computing devices over a communication network 112 through a communication module. The communication module 114 may be representative of a variety of communication components and functionality, including, but not limited to: one or more antennas; a browser; a transmitter and/or receiver (e.g., radio frequency circuitry); wireless radio; data ports; software interfaces and drivers; networking interfaces; data processing components; and so forth.

The communication network 112 may comprise a variety of different types of networks and connections that are contemplated, including, but not limited to: the Internet; an intranet; a satellite network; a cellular network; a mobile data network; wired and/or wireless connections; and so forth.

Wireless networks may comprise any of a plurality of communications standards, protocols and technologies, including, but not limited to: Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11 g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS), and/or Short Message Service (SMS)), or any other suitable communication protocol.

The computing device 102 includes a comparison module 116, which is storable in memory 106 and executable by the processor 104. The comparison module 116 is representative of functionality to analyze (determine) whether one or more parameters associated with a structural member, such as a structural steel member, represented in an orthographic representation (a three-dimensional representation of the structural member) at least approximately matches (equals) the corresponding parameters associated with a model defining the structural member. In an implementation, the structural member may be any type of structural member, or component, utilized to construct a structure, such as a building. For example, the structural member may include, but is not limited to: a column structure, a beam structure, a connector (e.g., a brace, etc.), a truss, or the like.

The computing device 102 is configured to convey one or more representations of the structural members. For example, a user may utilize a structural modeling software package, such as the SDS/2 software package, to model the structure to be built. It is contemplated that the user may be a detailer, such as a steel detailer, that is tasked with creating detailed representations (e.g., drawings, models, etc.) of the structure. Thus, the detailer may create structural models representing each structural member, or component, of the structure. Each structural model may include one or more parameters utilized to define the properties of the member that include, but are not limited to: dimensions (height, width, depth) of the member, member material type, dimensions between specific elements of the member to other structural members (e.g., distance between the bottom of a connector and the top of a wide flange beam), and so forth. In an implementation, the structural model may include a two-dimensional (2D) representation (e.g., drawing) of the structural member. For example, the drawing may be an engineering drawing. The data 118 representing each structural model is stored in a repository, such as memory 106 or a database.

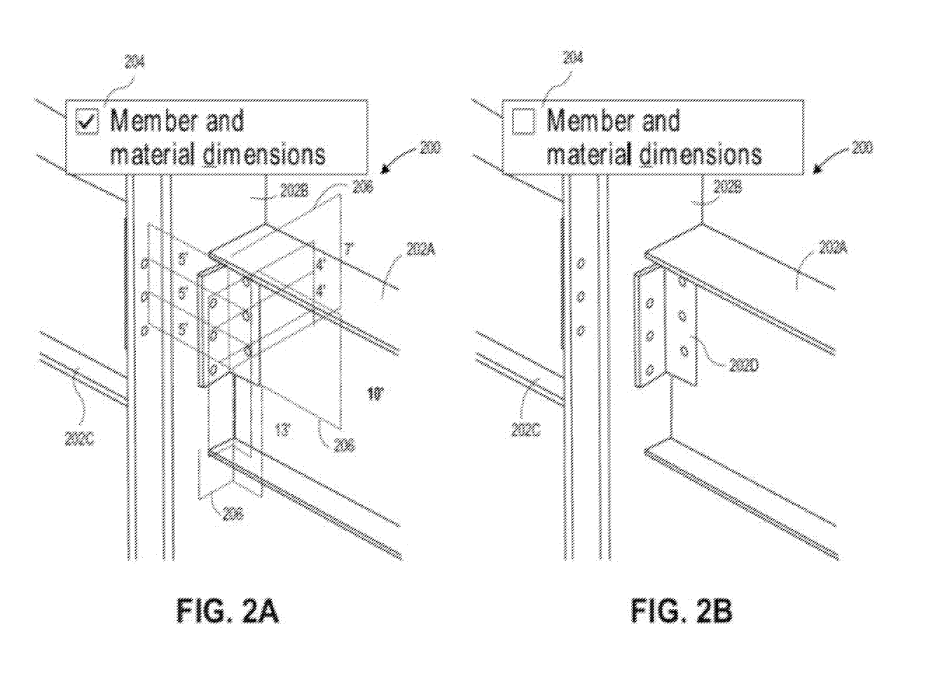

The detailer may also create a three-dimensional (3D) environment representation (e.g., drawings) of the structure with the same software package utilized to create the structural models described above. As shown in FIGS. 2A and 2B, the 3D environment representation 200 may include a 3D representation of every structural member (a 3D member representation) (e.g., members 202A, 202B, 202C, 202D) utilized to construct the structure. The 3D environment representation 200 also conveys how each member is to be connected within the structure. In an implementation, the 3D environment representation may be generated utilizing at least partially the structural models described above. Thus, each 3D member representation may include orthographic (3D) parameters that are utilized to define the properties of the structural members. These 3D parameters also include, but are not limited to: dimensions (height, width, depth) of the member, member material type, dimensions between specific elements of the member to other structural members, and so forth. Data 120 representing the 3D member representations, as well as the 3D environment representation of the structure, may be stored in a repository as well (e.g., memory 106, a database, etc.).

However, in some instances, the parameters of the structural model (structural model parameters) may not equal the corresponding 3D parameters of the 3D structural member representation. As described above, the comparison module 116 is configured to analyze whether the 3D parameters at least approximately matches the corresponding structural model parameters. In an implementation, the display device 108 is configured to display at least a portion of the 3D environment representation (see FIGS. 2A and 2B). The module 116 may also be configured to cause the processor 104 to display an interactive graphic that allows the user to toggle between a comparison mode and a non-comparison mode. For instance, the user may click a check box 204, select a radio button, or the like, to toggle between the comparison mode (see FIG. 2A) and the non-comparison mode (see FIG. 2B).

When the user enables the comparison mode, the user can select a 3D structural member representation to compare. In an implementation, the user may utilize a mouse to mouse over the desired 3D structural member representation, which instructs the module 116 to cause the processor 104 to analyze, or determine, whether the 3D parameters of the 3D structural member representation at least approximately matches the corresponding structural model parameters of the structural member. In an implementation, the processor 104 detects an input to initiate the module 116. For example, the processor 104 may cross-reference each 3D parameter to the corresponding structural model parameter.

According to a further preferred embodiment, the module 116 may preferably further cause the processor 104 to initiate a display of an overlay graphic 206 of at least one 3D parameter over the 3D structural member representation. For instance, as shown in FIG. 2, each dimension associated with the 3D connector representation is displayed over the 3D connector representation. In another instance, the module 116 may be configured to cause the processor 104 to initiate an overlay graphic of the 2D representation of the structural member (e.g., a 2D member drawing displayed over the 3D member drawing). For instance, one or more views of the 2D connector representation may be displayed over the 3D connector representation. It is contemplated that in another implementation the module 116 may have already caused the processor 104 to analyze each 3D parameter with the corresponding structural model parameter. Thus, the detection of the mouse over event may cause the module 116 to display (overlay) the parameters over the selected 3D member representation, as described below.

In addition to causing the display of the 3D parameters (dimensions) of the selected 3D member representation, the module 116 is configured to cause the processor 104 to initiate display of the 3D parameters in varying hues (colors) as a function of the analysis. For example, when the 3D parameter equals the structural model parameter, the processor 104 initiates display of the 3D parameter in a first hue, such as green (e.g., displayed 3D dimension matches corresponding structural member model dimension). In another example, when the 3D parameter does not equal, but the difference between the parameters is within a predetermined threshold, the processor 104 initiates display of the 3D parameter in a second hue, such as yellow. In yet another example, when the 3D parameter does not equal the structural model parameter and the difference between the parameters falls outside the predefined threshold (e.g., a one percent threshold, etc.), the processor 104 initiates display of the 3D parameter in a third hue, such as red. Thus, the user (e.g., detailer) may determine which member models require re-checking, which member models require modification, and whether the 3D environment representation of the structure should be re-generated. As shown in FIG. 2A, the non-bolded font represents the first hue and the bold font represents a hue other than the first hue.

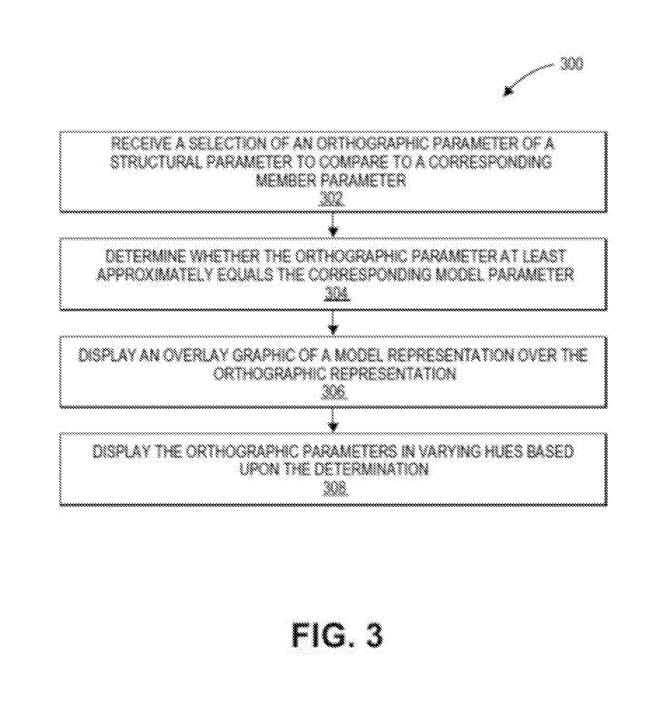

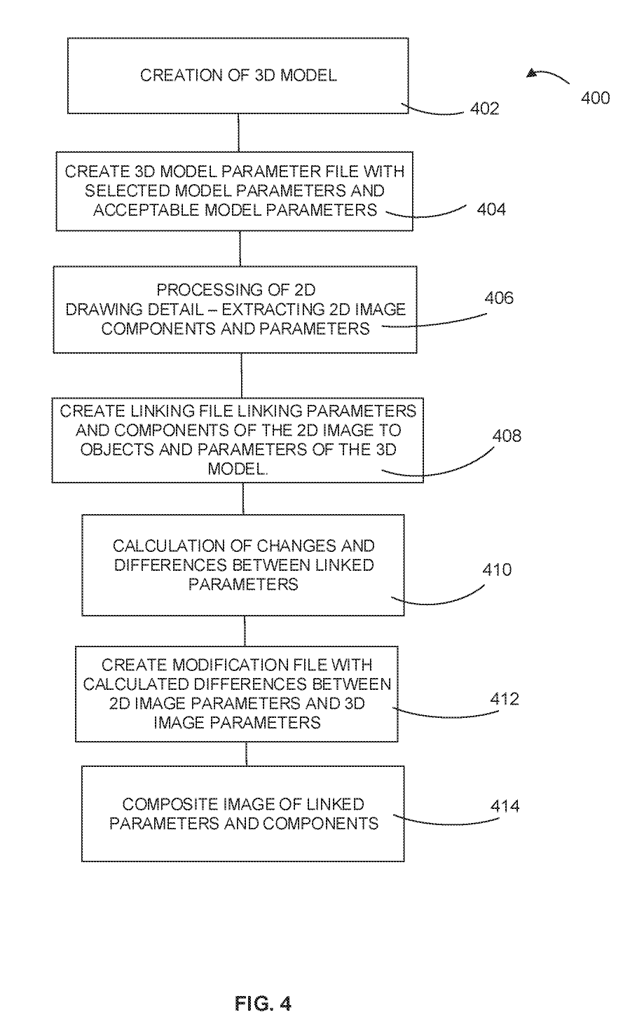

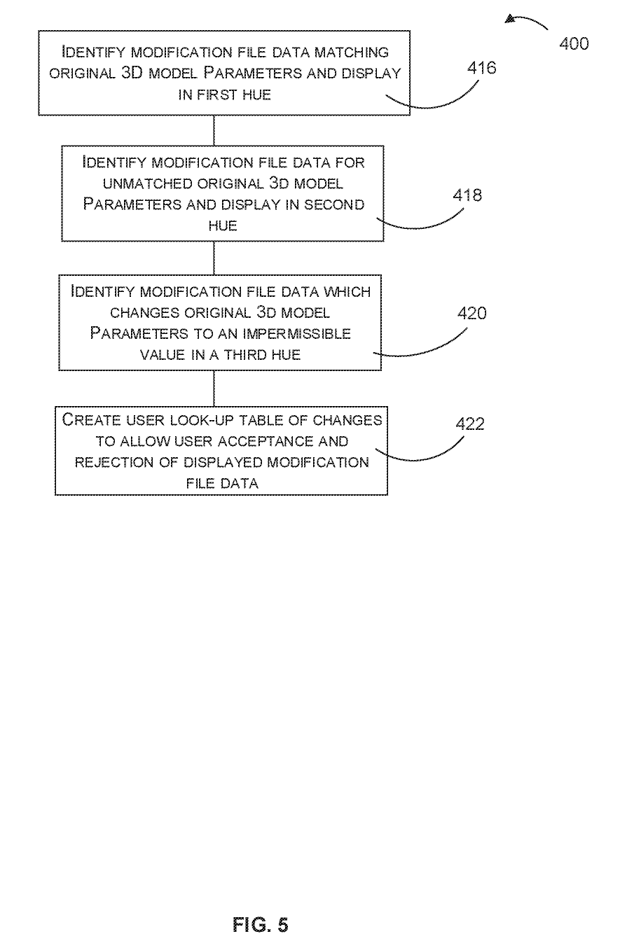

FIG. 3 illustrates an example method 300 for comparing an orthographic parameter to a corresponding structural model parameter. As shown in FIG. 3, a selection of an orthographic parameter to compare to a corresponding member parameter is received at a computing device (Block 302). For example, as described above, the user may select a structural member to cause the module 116 to compare whether the 3D parameters of the structural member at least approximately equal the corresponding structural model parameters. A determination is made of whether the orthographic parameter at least approximately equals (e.g., within a predetermined threshold) a corresponding structural model parameter (Block 304). In an implementation, the module 116 causes the processor 104 to determine whether the 3D parameters of the selected structural member at least approximately equal the corresponding structural model parameters. For example, the processor 104 may determine the 3D parameters at least approximately equal the corresponding structural model parameters when the 3D parameter values are within a predetermined tolerance, or range, of the corresponding structural model parameters. According to further preferred embodiments, exemplary methods/algorithms for comparing 3D parameters to corresponding structural model parameters are further disclosed with respect to FIGS. 4-6 discussed in more detail below.

As shown in FIG. 3, an overlay graphic of the model (2D) representation is displayed over the orthographic representation of the structural member (Block 306). In an implementation, the orthographic parameters are displayed in varying hues based upon the comparison (determination) to the corresponding structural model parameters (Block 308). For example, when the 3D parameter equals the structural model parameter, the processor 104 initiates display of the 3D parameter in a first hue, such as green (e.g., displayed 3D dimension matches corresponding structural member model dimension). In another example, when the 3D parameter does not equal, but the difference between the parameters is within a predefined threshold, the processor 104 initiates display of the 3D parameter in a second hue, such as yellow. In yet another example, when the 3D parameter does not equal the structural model parameter and the difference between the parameters falls outside the predefined threshold, the processor 104 initiates display of the 3D parameter in a third hue, such as red.

With reference now to FIG. 4, an exemplary algorithm 400 for integrating orthographic parameters with structural model parameters in accordance with further aspects of the present invention shall now be discussed. At a first step 402, the exemplary algorithm of the present invention may begin with a user either creating or opening an existing 3D model. At a next step 404, the exemplary algorithm preferably reads and/or creates a 3D model parameter file. According to a preferred embodiment, the 3D model parameter file may preferably include tables of selected 3D model parameters which may include data such as: model scales, distances, dimensions of model (i.e. height, length, depth, thickness, shape), dimensions and characteristics of model components (i.e. height, length, depth, thickness, shape, type, materials), 3D positioning of model components, and the positioning of model components relative to selected planes. According to a further preferred embodiment, the 3D model parameter file may preferably further include data indicating acceptable ranges and values for 3D model parameters. For example, the 3D model parameter file may include dimension data which indicates the thickness of a given wall to be 3 mm (i.e. the thickness parameter of a surface is stored as 3 mm) and further data may indicate alternative ranges for the wall thickness value (i.e. any whole number between 1 mm and 10 mm).

At a next step 406, the system of the present invention preferably receives, intakes and/or processes a 2D drawing detail. According to preferred embodiments, the 2D drawing detail may preferably be a 2D data file, a physical paper rendering, a raster file, a vector file or the like. According to further alternative preferred embodiments, the algorithm of the present invention may preferably further include a data processing engine to extract, parse, OCR and/or translate any dimensional information within the 2D drawing detail (i.e. raster, vector, ASCII data etc.) to create a 2D detail parameter file. Such a 2D detail parameter file may include parsed data from sources such as software notes, text legends, coding and other labels. Where numerical data is presented as text (either visually or in coding), the present invention preferably may translate the data (using OCR or the like) to numerical values for storage. Otherwise, the text may be input and identified as an unaccepted value as discussed further below.

According to further preferred embodiments, the algorithm of the present invention may preferably identify, parse and/or import the dimension data from the 2D image in a variety of ways. Such dimension data may be encoded in the 2D image file or may be scanned from a raster or vector image if a dimension label is present. Further, dimension data for a 2D image may be calculated based on the relative dimensions of a 2D image component compared with dimensions of the same component identified within the 3D object representation. Further, such image dimensions may be calculated based on the relative distances between 2D image components compared with distances between 3D image objects/representations.

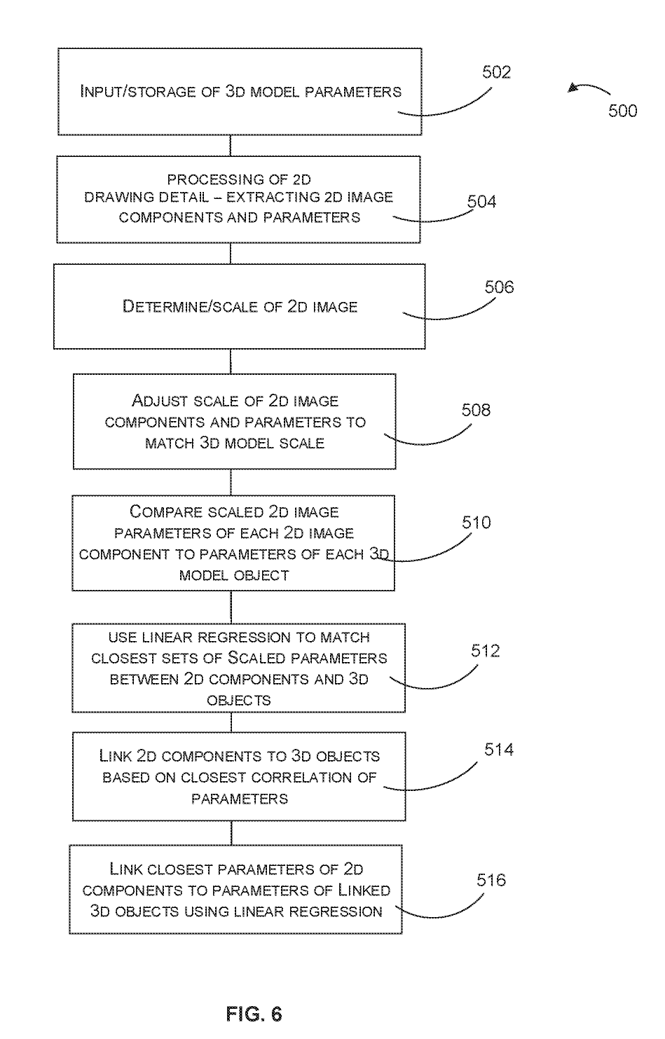

At a next step 408, a linking file may preferably be created including a table linking parameters and components of the 2D image to parameters and objects of the 3D model. An exemplary matching algorithm in accordance aspects of the present invention is further discussed with respect to FIG. 6 below.

At a next step 410, differences between the parameters of the 2D image components and the parameters of 3D model objects are preferably calculated and stored. At a next step 412, such data may be stored as a separate modification file or as a modification table within the linking file/table.

At a next step 414, a display is created including a composite of linked 2D image information and 3D model information. According to a preferred embodiment, the 2D image information may preferably be overlaid onto a 3D model rendering. Alternatively, the transparency, layer and display of each image may preferably be adjusted and arranged by the user.

According to further preferred embodiments, the composite images may preferably further include a display of linked parameters for each selected parameter, component and/or object. According to further preferred embodiments, the linked parameters may be individually selected for display or may remain hidden.

At a next step 416, modification file data for matched 2D structural model parameters and 3D model parameters are preferably displayed in a first hue. According to a first preferred embodiment, the matching data may be displayed in green. According to a further preferred embodiment, the modification file data may be considered matching if it is identical between the 2D structural model and the 3D model. Alternatively, the modification file data may be considered matching if the data is within a strict margin of error.

At a next step 418, modification file data for unmatched 2D structural model parameters and 3D model parameters are preferably displayed in a second hue. According to a further preferred embodiment, the unmatched data may be displayed in yellow. According to a further preferred embodiment, the modification file data may be considered unmatched if the data falls outside of a given margin of error.

At a next step 420, modification file data which includes unacceptable differences between the 2D structural model parameters and 3D model parameters are preferably displayed in a third hue. According to a preferred embodiment, the unacceptable data may be displayed in red. According to a preferred embodiment, the modification file data may be considered unacceptable if the data falls outside of a given margin of error and/or if the data does not meet further format requirements.

At a next step 422, the algorithm of the present invention preferably further provides a selectable display of linked parameters which allows users to select/reject displayed modification file data. According to a preferred embodiment, different displays may be used for each image component and may be stored separately. According to a further preferred embodiment, the displayed linked parameters may be stored as a look-up table for later reference and display.

With reference now to FIG. 6, an exemplary matching algorithm 500 for linking parameters and components of 2D structural models to parameters and objects of 3D models shall now be discussed. As shown in FIG. 4, aspects of the present invention include the creation of a linking file which may include a relational table/database linking parameters and components of 2D structural models to parameters and objects of 3D models. As shown in FIG. 6, an exemplary first step 502 for creating data for the linking file may preferably include the input/storage of 3D model parameters. At next step 504, a selected 2D image detail is preferably processed to identify 2D components and parameters. At a next step 506, the scale of the 2D image is preferably determined. Such dimension data may be encoded in the 2D image file or may be scanned from a raster or vector image of a dimension label if present. Further, dimension data for a 2D image may be calculated based on the relative dimensions of a 2D image component compared with dimensions of the same component identified within the 3D object. Further, such image dimensions may be calculated based on the relative distances between 2D image components and distances between 3D image objects.

At a next step 508, the algorithm preferably adjusts the scale of the 2D image components and parameters to match the scale of the 3D model. At a next step 510, the algorithm preferably compares the scaled 2D image parameters of each 2D image component to the parameters of each 3D model object. According to a preferred embodiment, the scaled 2D image parameters are preferably matched to scaled 3D object parameters by matching at least a pair of planar dimensions (length, height, width) and disregarding any 3D space data such as quadric surfaces, voxel space, graphics data and the like.

At a next step 512, linear regression is preferably used to match the closest sets of scaled parameters between 2D components and 3D objects. At a next step 514, the 2D components are preferably linked to selected 3D objects based on the closest determined correlations between the parameters for the 2D components and the parameters of 3D objects. At a next step 516, the algorithm may then preferably further link the parameters of the 2D components to selected parameters of the linked 3D objects using linear regression.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A method of generating a display of a two-dimensional rendering of a structural member overlaid on a three-dimensional representation of a structural model of a structure which includes a representation of the structural member, the method performed by a data processing system, the method comprising:
receiving, by a processor, a plurality of two-dimensional structural parameters associated with a first structural steel member, wherein the first structural steel member is selected from the group of structural steel members comprising: a beam structure, a connector, and a truss; wherein the structural steel member comprises a plurality of steel member structural elements;
modeling, by the processor, a first two-dimensional structural steel member representation of the first structural steel member incorporating at least one or more two-dimensional structural parameters;
rendering a first image of the first two-dimensional structural steel member representation modeled by the processor;
evaluating, by the processor, a three-dimensional environmental representation of a structure comprising a first plurality of structural steel members; wherein the first plurality of structural steel members includes the first structural steel member; further wherein the three-dimensional environmental representation of the structure comprises component orthographic data; wherein the component orthographic data defines one or more properties of the first plurality of structural steel members; further wherein the component orthographic data further comprises a plurality of dimensions defining the relative distances between the first plurality of structural steel members and how each structural steel member is connected within the structure;
rendering a second image of the three-dimensional structural model evaluated by the processor;
comparing, by the processor, at least one parameter of the plurality of two-dimensional structural parameters associated with the first structural steel member, with component orthographic data of the three-dimensional environmental representation of the structure; wherein the two dimensional structural parameters are compared with component orthographic data by cross-referencing at least one of the two-dimensional structural parameters associated with a structural steel member, with selected component orthographic data; wherein the cross-referencing associates at least one two-dimensional structural parameter with selected component orthographic data by matching parameters and orthographic data; and
rendering a third image, wherein the third image is composed at least in part of an overlay of a fourth rendered image of the two-dimensional structural steel member with a fifth image of the three-dimensional environmental representation of the structure evaluated by the processor;
wherein the overlay of the fourth image and the fifth image is performed at least in part based on the component orthographic data comprising the plurality of dimensions defining the relative distance between the plurality of steel member structural elements and the plurality of structural components.

2. The computing device as recited in claim 1, wherein the one or more modules are configured to cause the processor to cause display the at least one parameter in a second hue when the at least one orthographic parameter does not at least substantially equal the corresponding structural model parameter.

3. The computing device as recited in claim 2, wherein the first hue is green and the second hue is red.

4. The computing device as recited in claim 2, wherein the one or more modules are configured to display the at least one parameter in a third hue when the at least one orthographic parameter is within a predetermined threshold of the corresponding structural model parameter.

5. The computing device as recited in claim 1, wherein the input comprises a mouse over event.

6. The computing device as recited in claim 4, wherein the one or more modules is configured to cause an overlay graphic to be displayed within the orthographic environment in response to the detection of the input.

7. The computing device as recited in claim 6, wherein the overlay graphic represents dimensions of the corresponding orthographic parameter.
